(19) United States
(12) Patent Application Publication
(10) Pub. No.: US 2012/0056445 A1
(43) Pub. Date: Mar. 8, 2012

(54) Body Panel and Reinforcement Assembly

(75) Inventor: Sergey Fedorovich Golovashchenko, Beverly Hills, MI (US)

(73) Assignee: FORD GLOBAL TECHNOLOGIES, LLC, Dearborn, MI (US)

(21) Appl. No.: 12/875,358

(22) Filed: Sep. 3, 2010

(51) Int. Cl. B62D 25/00; B23P 15/00

(52) U.S. Cl. 296/191; 29/897.2

(57) ABSTRACT

A body panel assembly comprising an outer panel formed to a predetermined contour and a reinforcement assembly comprising a network or plurality of links that intersect to form a plurality of nodes. The network may be formed by a plurality of strips that are joined together at the nodes. The reinforcement assembly, or reinforcement panel, is attached with one surface flush to the outer body panel. One side of the reinforcement assembly is attached to the outer panel by brazing or bonding with an adhesive.

### BACKGROUND

1. Technical Field

Applicant's development relates to outer body panels that are reinforced to maintain bending stiffness while reducing the mass of the finished body panel.

2. Background

Mass is a key parameter for a body panel assembly for a vehicle. Vehicle body panels must have the required bending stiffness to ensure that they do not buckle under a specified load. Maintaining the bending stiffness of body panels assures the structural integrity of the vehicle.

One way to increase bending stiffness is to increase the thickness of an outer body panel. However, a major disadvantage of increasing the thickness of an outer body panel is that it also increases the mass of the panel.

The overall vehicle structure may weigh more if the thicknesses of the body panels are not minimized. Excess weight presents a problem when considering vehicle fuel efficiency. In order to achieve the lowest possible weight of the vehicle and maintaining the best possible fuel efficiency, the body panel thickness must be reduced, without compromising the structural integrity of the vehicle.

Body panel assemblies, such as vehicle doors and other assemblies that include an outer panel and an inner panel, require space inboard of the outer panel. The space between the outer panel and the inner panel may be used to house window operators, latches, speakers and electronics, but otherwise is not usable to accommodate passengers or cargo. The box-like configuration of body panel assemblies limits design freedom and reduces the space available within a vehicle.

There is a need for an improved vehicle body panel structure that provides strength without adding unnecessary weight, reduces space requirements, and addresses the above problems in a cost effective manner.

### SUMMARY

One aspect of this development is to provide a network of intersecting links that span the inner surface of an outer body panel to form a body panel assembly. The network is made up of thin strips that are bent to match the contour of the body panel assembly and may span part or all of the entire length and width of the body panel assembly. Links are also provided that are disposed about the periphery of the body panel assembly. The links may be made of lightweight ultra high strength steel.

Another aspect of this development relates to the method of making the body panel assembly that includes a network of links. One method of creating the network of links is to weld the links together. This may be done by first bending the links to a shape that matches the inner surface of the outer body panel, forming one or more recessed areas in some or all of the links, then placing the mating link into the recessed area, and welding the links together. The sides of the links are attached flush to the inner surface of the body panel. The network stiffens the body panel in multiple directions.

The network of links is attached to the body panel assembly in face-to-face, or flush, manner. One way of attaching the network to the outer body panel is by brazing. The edges of the flat side of the links are brazed, after being assembled to the inner surface of the body panel assembly. Brazing assures a strong bond between the network of links and the body panel assembly.

Another method of attaching the network of links to the body panel assembly is to bond the network of links to the body panel with an adhesive. An adhesive may be applied to the side of the network of links that is attached to the interior side of the body panel to form an assembly. The network of links is permanently attached to the body panel assembly ensuring the increased stiffness.

These and other aspects of the present development will be better understood in view of the attached drawings and the following detailed description of the illustrated embodiments.

### BRIEF DESCRIPTION OF THE DRAWINGS

FIG. 1 is an exploded side elevation view of a body panel assembly made according to the present disclosure;

FIG. 2 is an inside side elevation view of the outer body panel assembly;

FIG. 3 is a diagrammatic top plan view of a fixture, or modular carrier, that is shown holding a plurality of strips in position for loading into a bending die;

FIG. 4 is a diagrammatic cross-sectional view taken along the line 4-4 in FIG. 3 of a bending die that is shown bending the strips while being held by the fixture or modular carrier;

FIG. 5 is a cross-sectional view taken along the line 5-5 in FIG. 2; and

FIG. 6 is a fragmentary inside elevation view showing a reinforcement assembly assembled to an outer body panel.

### DETAILED DESCRIPTION

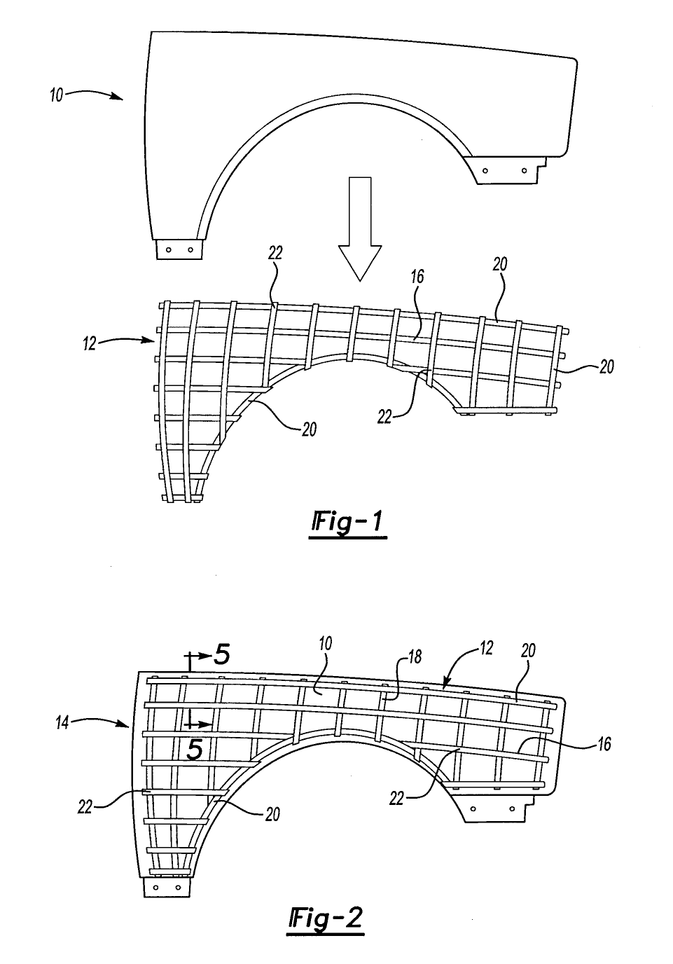

Referring to FIGS. 1 and 2, an outer body panel 10 is shown detached from a reinforcement assembly 12 that is formed to the same shape and contour as the outer body panel 10. The reinforcement assembly 12 and outer body panel 10 are bonded together by an adhesive or brazing process to form an outer body panel assembly 14, as shown in FIG. 2.

The reinforcement assembly 12 is composed of a network of strips, or links, that may be made of lightweight ultra high strength steel (for example, dual phase steel DP980). The network includes a plurality of first strips 16 that extend generally in the longitudinal vehicle direction and a plurality of second strips 18 that extend generally vertically, as shown in FIG. 1. The first strips 16 could alternatively extend in an inclined or non-horizontal direction and the second strips 18 could extend in an angled or non-vertical direction. A plurality of edge strips 20 are provided that extend about the reinforcement assembly 12 and correspond generally to the outline of the outer body panel 10. The first and second strips 16 and 18 and edge strips 20 are attached to each other at nodes 22 that are formed by the intersection of two or more of the strips.

Referring to FIG. 2, the reinforcement assembly 12 is shown as it is attached to the outer body panel 10. The first strips 16, second strips 18 and edge strips 20 may also be referred to as links. The links may extend the full width of the outer body panel 10 or may be links that extend between two or more nodes 22. The reinforcement assembly 12 follows the contour and strengthens the outer body panel to provide increased bending stiffness in the finished assembly.

High strength steels and aluminum are less ductile than mild steel and have much lower formability. These high strength lightweight materials are more difficult to draw than mild steel that is commonly used to form inner and outer panels of body panel assemblies. To overcome this limitation, the strips 16, 18 are placed in a fixture 24, or modular carrier, in a crossing pattern. The fixture 24 is then placed in a bending die generally referred to by reference numeral 26. The bending die includes a punch 28 and a lower die 30. The fixture 24 clamps the strips 16 and 18 and allows material flow into the bending die 26 while the strips 16 and 18 are bent to the desired contour. The fixture 24 engages the ends of the strips 16 and 18 and stretches the strips at that location to a limited extent at the end of the forming process. The strips 16 and 18 are bent to the contour and are less subject to springback when stretched than would occur if high strength steel or aluminum panels are attempted to be drawn to the same contour.

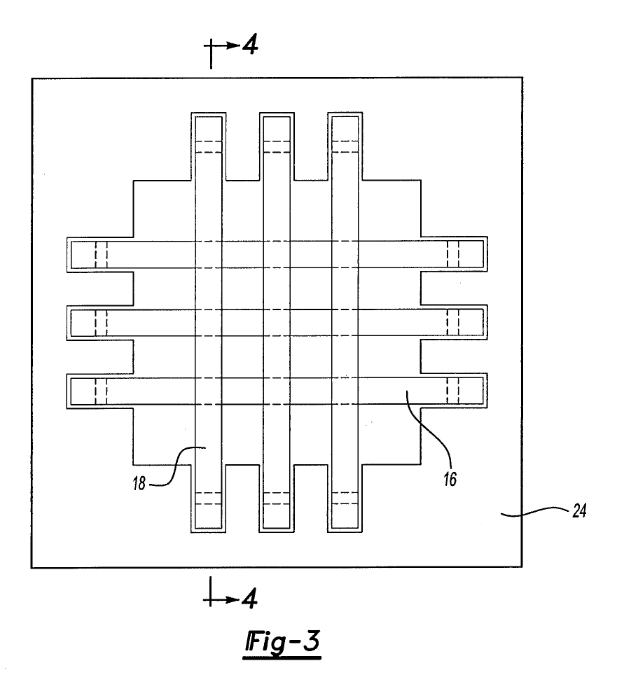

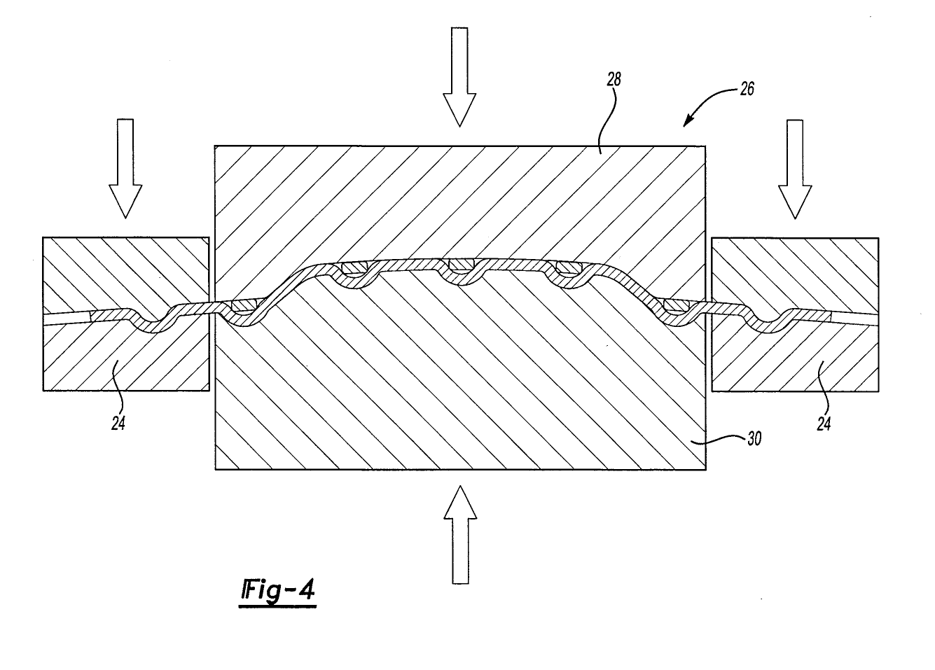

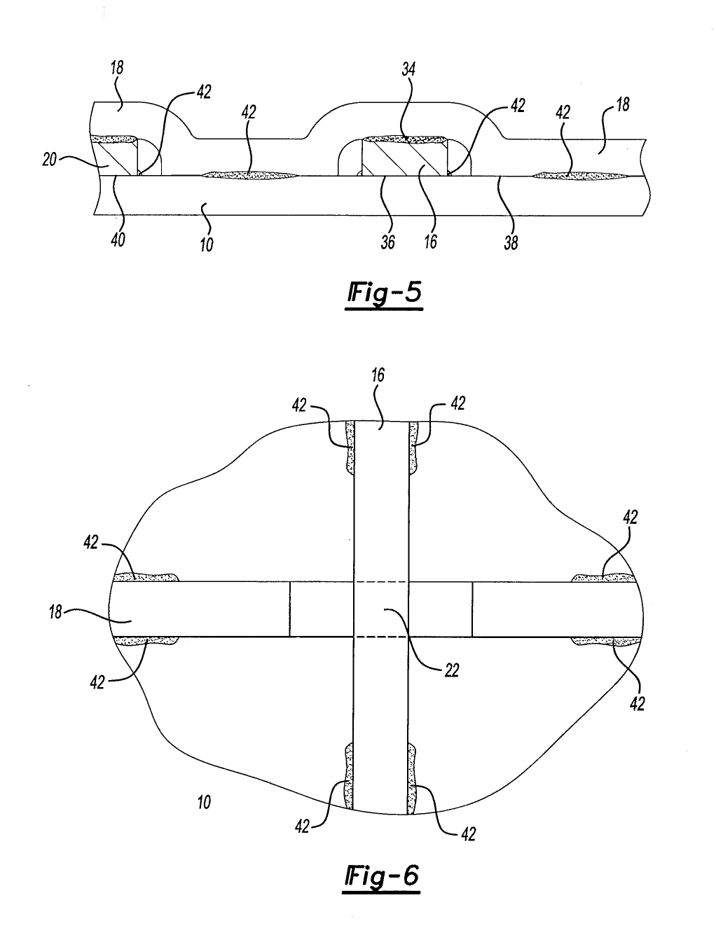

Referring to FIG. 5, one of the first strips 16 is shown attached to one of the second strips 18 by a weld 34. The weld 34 is formed at one of the nodes 22 of the reinforcement assembly 12. The first strips 16 have a first flush surface 36 that is contoured to fit in a face-to-face relationship, or flush with the outer body panel 10. Similarly, a second flush surface 38 is formed on the second strip 18 that is likewise adapted to be secured to the outer body panel 10 in a face-to-face relationship. A third flush surface 40 is provided on the edge strips 20 and is also adapted to be attached flush to the outer body panel 10. Brazing deposits 42 are shown in FIG. 3 and may be applied in a continuous or discontinuous manner to secure the first strips 16, second strips 18 and edge strips 20 to the outer body panel 10.

Alternatively, the strips 16, 18 and 20 could be attached to the outer body panel 10 by gluing the flush surfaces 36, 38 and 40 to the outer body panel 10. The adhesive bonding agent is not shown in FIG. 3 because it may not be visible to the ordinary observer.

Referring to FIG. 6, one of the first strips 16 is shown attached to one of the second strips 18 at a node 22. The first and second strips 16 and 18 are attached to the outer body 10 by brazing as indicated by the brazing deposits 42. As previously indicated, if an adhesive bonding agent is used, it may not be visible.

Although embodiments of the invention have been disclosed, it will be apparent to persons skilled in the art that modifications may be made without departing from the scope of the invention. All such modifications and equivalents thereof are intended to be defined by the following claims.

What is claimed:

1. A body panel assembly for a vehicle, comprising:
an outer panel that is formed to a predetermined contour, the panel having an outer side and an inner side;
a reinforcement assembly comprising a network including a plurality of links that have a first side and a second side, the network of links overlie one another and form a plurality of nodes;
the links are each formed to conform to one of a plurality of selected areas of the inner side of the panel, wherein the network is attached to the outer panel with the first side of the links being bonded to the selected area with the first side being flush with the inner side of the outer panel.

2. The body panel assembly of claim 1 wherein the network further comprises a plurality of first, second and edge links that are connected together and wherein the network spans the inner side of the panel.

3. The body panel assembly of claim 2 wherein the plurality of first, second and edge links have a first flush surface, a second flush surface, and a third flush surface, respectively.

4. The body panel assembly of claim 1 wherein the links are formed of sheet metal and the links are welded together before being attached to the selected areas.

5. The body panel assembly of claim 1 wherein the links are bonded to the selected areas by brazing.

6. The body panel assembly of claim 1 wherein the links are bonded to the selected areas by an adhesive.

7. A method for making a body panel assembly for a vehicle comprising:
forming an outer body panel to a predetermined contour, having an outer side and an inner side;
creating a reinforcement assembly comprising a network including a plurality of links that have a first and second side, conforming to a plurality of selected areas of the sheet metal panel, whereas the plurality of links intersect each other to form a plurality of spaced apart nodes;
bonding the first side of the network of links to the inner side of the outer body panel.

8. A method for making a body panel assembly for a vehicle as recited in claim 7 wherein the plurality of links is created by assembling a plurality of individual strips together in a fixture, bending the strips to a desired contour, and welding the strips to each other at nodes formed by the intersection of two strips.

9. A method for making a body panel assembly for a vehicle as recited in claim 8 wherein the formed and welded strips are brazed to the outer body panel.

10. A method for making a body panel assembly for a vehicle comprising:
forming an outer body panel to a predetermined contour, having an outer side and an inner side;
forming a reinforcement panel including a plurality of intersecting strips bent to a desired contour and welded to each other; and
attaching the reinforcement panel to the outer body panel in a face-to-face, or flush, relationship.

11. The method for making a body panel assembly for a vehicle as recited in claim 10 wherein the step of attaching the reinforcement panel to the outer body panel is performed with an adhesive.

12. The method for making a body panel assembly for a vehicle as recited in claim 10 wherein the step of attaching the links is performed by brazing.
